(19) United States
(12) Patent Application Publication
(10) Pub. No.: US 2010/0223668 A1
(43) Pub. Date: Sep. 2, 2010

(54) APPARATUS AND METHOD FOR MANAGING TERMINAL USERS

(75) Inventors: Yongbon Koo, Daejon (KR); Yungjoon Jung, Daejon (KR); Jaemyoung Kim, Daejon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-City (KR)

(21) Appl. No.: 12/738,002

(22) PCT Filed: Aug. 20, 2008
(86) PCT No.: PCT/KR2008/004816

§ 371 Date: Apr. 14, 2010

(30) Foreign Application Priority Data
Oct. 15, 2007 (KR) 10-2007-0103556

(51) Int. Cl. G06F 11/30

(52) U.S. Cl. 726/22

(57) ABSTRACT

The present invention relates to an apparatus and method of managing terminal users that is capable of securely managing personal information and data of a user in a mobile terminal. An embodiment of the present invention provides an apparatus and method of managing terminal users that monitors whether a terminal of a user is abnormally used, including whether the terminal is not used over a predetermined period of time, to collect and check data, and, when it is determined that the terminal is abnormally used as a checked result, forces the user to log out. Therefore, a login situation of the user can be accurately recognized, and the internal operation of the terminal can be secured from external users to securely manage user data and improve security.

### TECHNICAL FIELD

The present invention relates to an apparatus and method of managing terminal users that is capable of securely managing personal information and data of a user in a mobile terminal. More particularly, the present invention relates to an apparatus and method of managing terminal users that is capable of protecting the users in the case of losing control right of mobile terminals, in managing personal information and data of mobile terminal users.

This work was supported by the IT R&D program of MIC/IITA [2006-S-038-02, Development of Device-Adaptive Embedded Operating System for Mobile Convergence Computing].

### BACKGROUND ART

In recent years, as the technology for personal mobile apparatuses has rapidly developed and costs of mobile terminals have decreased, various kinds of mobile terminals, such as cellular phones and PDAs, are being commonly used. As the availability of mobile apparatuses increases, many users are increasingly storing their own important data in the mobile apparatuses and frequently accessing the stored information. The more the mobile apparatuses become popular, the higher the security threat to the mobile terminals becomes.

In order to solve this problem, various methods of securely managing user information and data have been suggested. However, in the existing methods, such as a method based on an ID/password to be generally used, it is required for a user to specifically input a logout command. For this reason, when the user forgets to input a logout command, the user is exposed to the threat to information leakage. In particular, if the mobile terminal of the user is lost or stolen, the user cannot input a logout command, which may result in losing important data. Further, if confidential data is exposed to other users and put to a bad use, it may cause a great disaster. That is, according to the methods in the related art, there is a problem in that, when a user loses the control right of a mobile terminal, it causes a security problem.

### DISCLOSURE OF INVENTION

### Technical Problem

The prevent invention has been made to solve the above-described problems, and it is an object of the present invention to provide an apparatus and method that is capable of causing a user to use a reliable mobile storage device when using a mobile terminal so as to ensure the reliability of terminal utilization, and confirming a user behavior and a terminal operation situation even if the user unexpectedly cannot use the mobile terminal, such that a login situation can be accurately recognized.

Further, the present invention uses a method of signing a user virtual space using user information as a key. As a result, since a terminal internal operation is secured from external users, it is possible to securely manage user data and improve security.

### Technical Solution

According to an aspect of the present invention, there is provided an apparatus for managing terminal users. The apparatus includes a monitoring information collecting module that monitors whether a terminal of a user is abnormally used, including whether the terminal is not used over a predetermined period of time, and collects information; and a control unit that checks the information collected by the monitoring information collecting module, and, when it is determined that the terminal is abnormally used as a checked result, compulsorily logs out the user.

The monitoring information collecting module may include an input unit to which a user command is input, and the control unit compulsorily logs out the user, when a threshold time or more elapses after final input from the user through the input unit.

The monitoring information collecting module may include a motion detecting unit that detects a motion of the terminal, and the control unit compulsorily logs out the user when the magnitude of the motion of the terminal detected by the motion detecting unit is equal to or larger than a threshold value.

The monitoring information collecting module may include a virtual space manager that checks whether a threshold time or more elapses after a final access time for a user virtual space set to the user or whether a CPU scheduling time for a user program elapses by a threshold time or more, and reports a checked result to the control unit.

The control unit may compulsorily log out the user, when the threshold time or more elapses after the final access for the user virtual space set to the user or when the threshold time or more elapses after the final CPU scheduling time for the user program.

The apparatus according to the aspect of the present invention may further include an authentication information receiving unit that receives user authentication information from a mobile storage device through wireless communication.

The control unit may compulsorily log out the user and securely delete a user virtual space set to the user.

According to another aspect of the present invention, there is provided a system for managing terminal users. The system includes a mobile storage device, that stores user information and includes a wireless communication module; and a mobile terminal that receives the user information from the mobile storage device and sets a user virtual space for the corresponding user, monitors whether a terminal of the user is abnormally used, including whether the terminal is not used over a predetermined period of time, to collect and check data, and, when it is determined that the terminal is abnormally used as a checked result, compulsorily logs out the user and securely deletes the user virtual space set to the user.

According to still another aspect of the present invention, there is provided a method of managing terminal users. The method includes a monitoring information collecting step of monitoring whether a terminal of a user is abnormally used, including whether the terminal is not used over a predetermined period of time, and collecting information; and a logout step of checking the information collected in the monitoring information collecting step and, when it is determined that the terminal is abnormally used as a checked result, compulsorily logging out the user.

### ADVANTAGEOUS EFFECTS

According to the present invention, a login situation of a user can be accurately recognized and a terminal internal operation can be secured from external users. Therefore, it is possible to securely manage user data and improve security.

### BRIEF DESCRIPTION OF THE DRAWINGS

FIG. 1 is a diagram illustrating a block structure of a communication system to which the present invention is applied.

FIG. 2 is a diagram illustrating an inner structure of a mobile terminal according to an embodiment of the present invention.

FIG. 3 is a diagram illustrating an operation flow of a terminal according to an embodiment of the present invention.

FIG. 4 is a diagram illustrating an example of a re-login warning message according to the present invention.

### BEST MODE FOR CARRYING OUT THE INVENTION

Hereinafter, the preferred embodiment of the present invention will be described in detail with reference to the accompanying drawings.

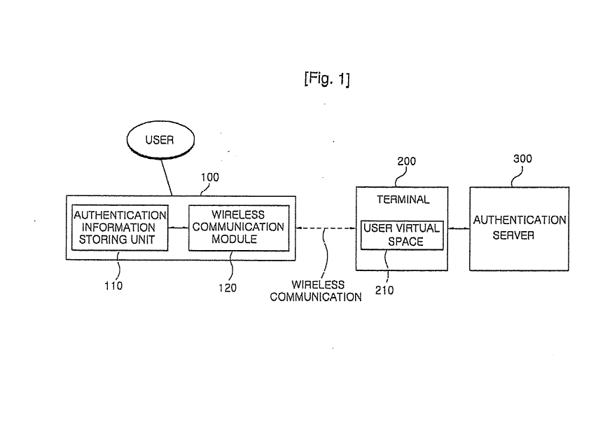

FIG. 1 shows a block structure of a communication system to which the present invention is applied.

As shown in FIG. 1, a type of a communication system to which the present invention is applied is not limited to a specific type, as long as the communication system includes a terminal 200 that is connected to an authentication server 300. In general, the authentication server 300 and the terminal 200 communicate with each other by a wireless communication method, in the case of a wireless terminal. However, the present invention is not limited thereto. Accordingly, as a communication method with the authentication server 300, both a wireless communication method and a wired communication method may be used.

A data managing apparatus of the terminal according to the present invention needs a mobile storage device 100, such as a USB. When a user who possesses the mobile storage device 100 accesses the terminal 200 within a predetermined distance, that is, the mobile storage device 100 according to the present invention accesses the terminal 200 within the predetermined distance, the terminal 200 detects a signal that is output from a wireless communication module 120 of the mobile storage device 100 and recognizes that the mobile storage device 100 exists. The terminal 200 that has recognized that the mobile storage device 100 exists sets a communication path with the mobile storage device 100, and requests the mobile storage device 100 to transmit user information stored in an authentication information storing unit 110 thereof. After receiving the request, the mobile storage device 100 transmits the user information to the terminal 200. The terminal 200 receives the user information and releases the set communication path. An example of a communication method between the terminal 200 and the mobile storage device 100 may be RFID. In this case, the wireless communication module 120 of the mobile storage device may be an RFID chip, and the terminal 200 is configured to include a wireless communication module that can communicate with the wireless communication module 120 of the mobile storage device.

After acquiring the user information from the mobile storage device 100, the terminal 200 transmits the user information to the authentication server 300, such that the authentication server 300 performs an authentication process on the corresponding user. The authentication server 300 shown in FIG. 1 is mainly used to authenticate users, but may function as a data server that stores the user information. Of course, the authentication server 300 and the data server may be constructed by separate hardware.

If the authentication server 300 completes an authentication process, the authentication server 300 notifies the terminal 200 of an authentication result. On the basis of the corresponding user information, the terminal 200 generates a user virtual space 210 therein, and exclusively assigns terminal resources needed in the user virtual space 210, for example, a CPU scheduling time, a memory region, a storage device space, and a network bandwidth, to a specific user. Here, the user virtual space is used to exclusively assign terminal resources to a specific user to protect the terminal resources from the other users. Also, the user virtual space is used to limit a user operation within a predetermined range so as to prevent unnecessary system utilization from the corresponding user.

If the user virtual space 210 is set, only the mobile storage device that stores the corresponding user information can access the user virtual space 210. That is, except for a user that has a mobile storage device that stores information on a qualified user, an access on the corresponding user virtual space 210 from the other users is blocked.

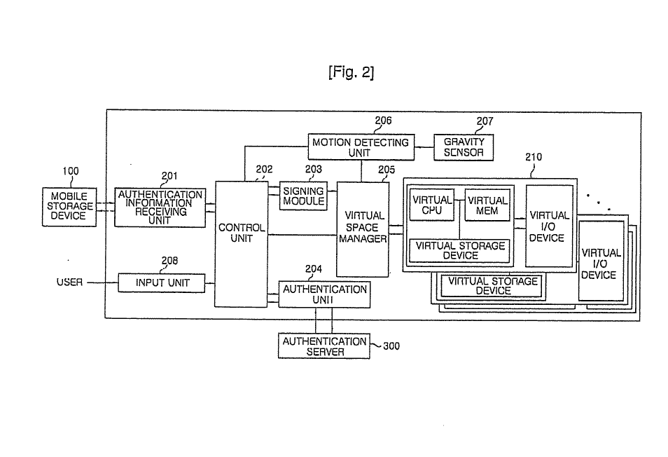

FIG. 2 shows an inner structure of a mobile terminal according to an embodiment of the present invention.

A mobile terminal according to the present invention includes an authentication information receiving unit 201, a control unit 202, a signing module 203, an authentication unit 204, a virtual space manager 205, a motion detecting unit 206, a gravity sensor 207, an input unit 208, and a user virtual space 210.

The authentication information receiving unit 201 receives user authentication information from the mobile storage device 100 that a user has, through wireless communication. The received user authentication information is input to the control unit 202. The control unit 202 is connected to the signing module 203, the authentication unit 204, the virtual space manager 205, the motion detecting unit 206, and the input unit 208 as well as the authentication information receiving unit 201, and receives data input therefrom. According to the received data, the control unit 202 determines processes to be performed on the logout and virtual space of the corresponding user, and outputs a corresponding command.

The signing module 203 uses the user authentication information to sign a user virtual space, such that it is possible to prevent the other users who do not have the user authentication information of the corresponding user from illegally obtaining access into the user virtual space. The authentication unit 205 communicates with the authentication server 300 to perform user authentication. The virtual space manager 205 monitors operation situations of a CPU, a memory, and a storage device in the user virtual space 210, and collects data related to the present invention.

The motion detecting unit 206 detects a motion of the terminal on the basis of a value input from the gravity sensor 207. Data on the motion of the terminal is reported to the control unit 202 by the motion detecting unit 206, such that the data is used in determining whether logout is performed or not.

The input unit 208 is a device, such as a keypad and a touch screen, and data input through the input unit 208 is output to the control unit 202. The control unit 202 analyzes an input pattern in which the user inputs data through the input unit 208, and determines whether logout is performed or not.

Hereinafter, the operations of constituent elements shown in FIG. 2 will be described with reference to the flowchart shown in FIG. 3.

FIG. 3 shows an operation flow of a terminal according to an embodiment of the present invention.

The terminal according to the present invention continuously collects monitoring information (S310). In this case, the monitoring information includes a time at which the user starts to input data using the input device and a time that elapses after a final input time, an access time of a virtual memory and a virtual storage device in the user virtual space 210 and a time that elapses after a final access time, a CPU scheduling time that is assigned to a user program, and a motion of the terminal that is detected by the gravity sensor 207 in the terminal.

When a user does not intentionally input a logout command (No of S320), it is determined whether the monitoring data collected using the above-described method satisfies predetermined conditions so as to determine whether the procedure proceeds to a user virtual space deletion process and a logout process (S331 to S390).

Specifically, it is determined whether a threshold time or more elapses after the final input from a user (S331). At this time, when it is determined that the threshold time or more elapses (Yes of S331), a re-login warning message is displayed to the user in order to clearly confirm the intention of the user (S340). This is because of the following reason. When no data is input through the input device for a predetermined time, it is determined that the user does not use the terminal.

When the threshold time does not elapse after the final input from the user, it is determined whether the threshold time or more elapses after the final access time on the user virtual space 210 (S332). In this case, the threshold time on the input from the user and the threshold time of the access time on the user virtual space 210 may be set to the same value or different values according to a characteristic of the apparatus and an object of system management. When the threshold time or more elapses after the access time on the user virtual space 210 (Yes of S332), the procedure proceeds to a re-login warning message displaying step (S340).

However, when the threshold time does not elapse after the access time on the user virtual space 210 (No of S332), it is checked whether the CPU scheduling time on the user program elapses by the threshold time or more (S333). When it is checked that the CPU scheduling time elapses by the threshold time or more (Yes of S333), the procedure proceeds to the re-login warning message displaying step (S340).

When the CPU scheduling time does not elapse the threshold time or more (No of S333), it is checked whether the gravity sensor detects a motion of a threshold value or more (S334). When it is checked that the gravity sensor detects the motion of the threshold value or more (Yes of S334), it is determined that a rapid change is generated in the terminal, and the procedure proceeds to the re-login warning message displaying step (S340). When it is checked that the gravity sensor does not detect the motion of the threshold value or more (No of S334), the procedure proceeds to the monitoring information collecting step (S310).

In brief, if any one of the four results of checking is Yes, the procedure proceeds to the re-login warning message displaying step (S340). If all of the four checked results are No, the process returns to the monitoring information collecting step (S310) to collect the monitoring information, and the above-described procedure is repeated.

The monitoring information checking procedure described in FIG. 3 is sequentially performed, but is only an example to implement the present invention. The four checking steps may be performed at the same time.

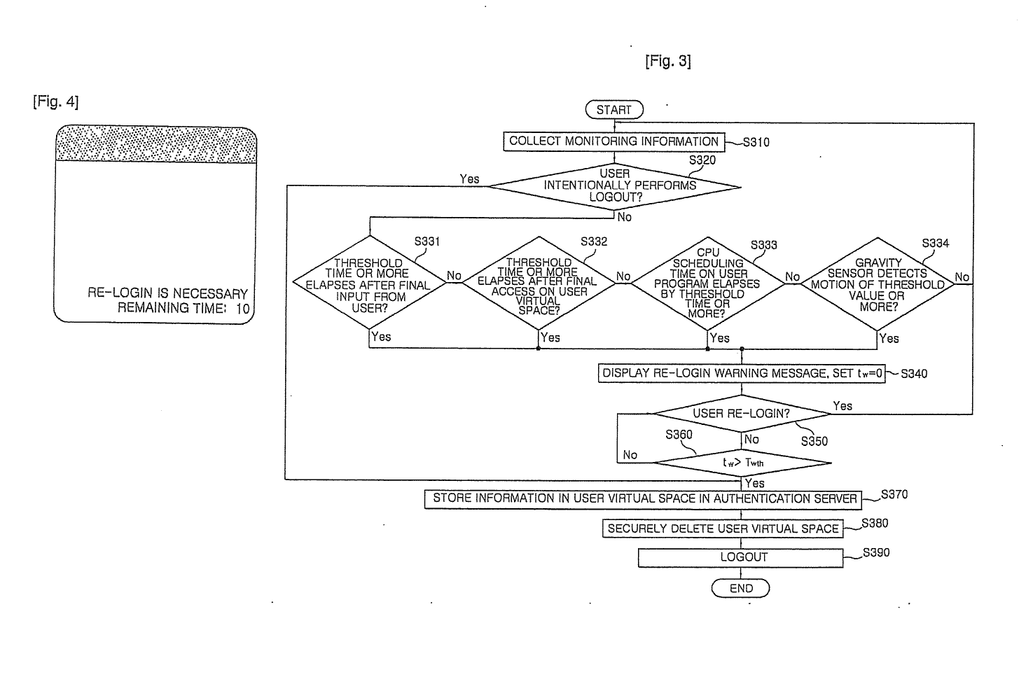

The procedure after the re-login warning message displaying step (S340) will be described. The re-login warning message may be displayed as shown in FIG. 4. In the re-login warning message displaying step (S340), a variable tw is set to a value of 0. In this case, the variable tw is used to measure the time, which is needed until a user who has discovered the re-login warning message performs a re-login process, and indicates an elapsed time after displaying the re-login warning message. When the user who receives the re-login warning message performs a re-login process before a threshold time Twth elapses (S350), the terminal repeats the monitoring information collecting step (S310). In Step S350, when the user does not perform the re-login process, it is checked again that tw is larger than Twth (S360). When it is checked that the tw is smaller or equal to Twth, the process (S350) that checks whether the user performs the re-login process is repeated. That is, the terminal waits for the predetermined time to check whether the user performs the re-login process. When the user performs the re-login process, the procedure proceeds to the monitoring information collecting step (S310), and when the user does not perform the login process, the logout process is performed.

When the user executes a program to reproduce multimedia, such as a motion picture or a music, the re-login warning message displaying step (S340) that has been described above is a procedure for the case where the user input is not made but the user does not intend to perform the logout process, and may be omitted in consideration of a system characteristic, if necessary.

Meanwhile, when the user does not perform the re-login process even after the Twth time (Yes of S360), changed contents among information in the user virtual space 300 are updated and stored in the authentication server 300 (S370), and the corresponding user virtual space 300 is securely deleted. In this case, the deleting securely means that the deletion is made such that restoration is impossible, which is a procedure for preventing fraudulent utilization of the terminal in a hardware type.

1. An apparatus for managing terminal users, the apparatus comprising:
a monitoring information collecting module that monitors an abnormal use of a terminal, including whether the terminal is not used over a predetermined period of time by the user, and collects information; and
a control unit that checks the information collected by the monitoring information collecting module, and, when it is determined that the terminal is abnormally used, forces the user to log out.

2. The apparatus of claim 1,
wherein the monitoring information collecting module includes an input unit to which a user command is input, and the control unit forces the user to log out when a threshold time or more elapses after the final input from the user through the input unit.

3. The apparatus of claim 1,
wherein the monitoring information collecting module includes a motion detecting unit that detects a motion of the terminal, and the control unit forces the user to log out when the magnitude of the motion of the terminal detected by the motion detecting unit is equal to or larger than a threshold value.

4. The apparatus of claim 1,
wherein the monitoring information collecting module includes a virtual space manager that checks whether a threshold time or more elapses after the final access time for a user virtual space designated for the user or whether a threshold time or more elapses after the final CPU scheduling time for a user program, and reports a checked result to the control unit, and
the control unit forces the user to log out when the threshold time or more elapses after the final access time for the user virtual space designated for the user or when the threshold time or more elapses after the final CPU scheduling time for the user program.

5. The apparatus of claim 1, further comprising:
an authentication information receiving unit that receives user authentication information from a mobile storage device through wireless communication.

6. The apparatus of claim 1,
wherein the control unit forces the user to log out and securely deletes a user virtual space designated for the user.

7. A system for managing terminal users, the system comprising:
a mobile storage device that stores user information and includes a wireless communication module; and
a mobile terminal that receives the user information from the mobile storage device, designates a user virtual space for the corresponding user, monitors an abnormal use of the terminal, including whether the terminal is not used over a predetermined period of time by the user, collects data and checks the collected data, wherein the mobile terminal forces the user to log out and securely deletes the user virtual space designated for the user when it is determined that the terminal is abnormally used.

8. The system of claim 7, further comprising:
an authentication server that includes a database on at least one user information and authentication information, and receives a user authentication request of specific user information from the mobile terminal and transmits an authentication performed result on the corresponding user information to the mobile terminal.

9. The system of claim 8,
wherein the mobile terminal includes a wireless communication module that communicates with a wireless communication module of the mobile storage device, and
the mobile terminal receives the user information that is stored in the mobile storage device and requests the authentication server to authenticate the corresponding user.

10. A method of managing terminal users, the method comprising:
a monitoring information collecting step of monitoring whether a terminal is abnormally used, including whether the terminal is not used over a predetermined period of time by the user, and collecting information; and
a logout step of checking the information collected in the monitoring information collecting step and, when it is determined that the terminal is abnormally used, forcing the user to log out.

11. The method of claim 10,
wherein the monitoring information collecting step includes a step of receiving a command input from the user, and the logout step is characterized by forcing the user to log out when a threshold time or more elapses after the final input of a user command.

12. The method of claim 10,
wherein the monitoring information collecting step includes a motion detecting step of detecting a motion of the terminal, and the logout step is characterized by forcing the user to log out when the magnitude of the motion of the terminal detected through the motion detecting step is equal to or larger than a threshold value.

13. The method of claim 10,
wherein the monitoring information collecting step includes a step of checking whether a threshold time or more elapses after the final access time for a user virtual space designated for the user, and the logout step is characterized by forcing the user to log out when the threshold time or more elapses after the final access for the user virtual space designated for the user.

14. The method of claim 10,
wherein the monitoring information collecting step includes a step of checking whether a CPU scheduling time for a user program elapses by a threshold time or more, and wherein forces the user to log out when the threshold time or more elapses after the final CPU scheduling time for the user program.

15. The method of claim 10, further comprising:
an authentication information receiving step of receiving user information from a mobile storage device through wireless communication; and
a step of designating a user virtual space for the corresponding user on the basis of the received user information.

16. The method of claim 10,
wherein the logout step includes a step of securely deleting a user virtual space designated for the user after forcing the user to log out.
